(19) United States
(12) Patent Application Publication
(10) Pub. No.: US 2003/0098913 A1
(43) Pub. Date: May 29, 2003

(54) Digital swift video controller system

(75) Inventor: Ming-Shun Chang, Taipei (TW)

Correspondence Address: BACON & THOMAS, PLLC, 625 SLATERS LANE, FOURTH FLOOR, ALEXANDRIA, VA, 22314

(73) Assignee: LIGHTING INNOVATION & SERVICES CO., LTD.

(21) Appl. No.: 09/995,825

(22) Filed: Nov. 29, 2001

(51) Int. Cl. H04N 5/232

(52) U.S. Cl. 348/211.13; 348/211.1; 348/211.5

(57) ABSTRACT

A digital swift video controller system that can be used in a wide spreading area. The present system is activated by transmitting digital video camera image to the arena telecom server and then stored in the high capacity image-storing device, such as magnetic disk and CD-Rom. Specialist is then monitoring all these image data in the central control unit and then they are able to transmit the requested image data to user. These image data are transmitted through Asymmetric Digital Subscriber Line (ADSL) offered by the central telecom company in Taiwan upon users personal authorized estate and pin code. By way of transmitting image data, user will be able to view the request images instantly either live or historically on an personal computer providing there is an Asymmetric Digital Subscriber Line (ADSL) connection. This system will enable user to monitoring any image data upon their personal authorized estate and pin code more conveniently and effectively.

### BACKGROUND OF THE INVENTION

The present invention is related to a digital swift video controller system that can be used in a wide spreading area. The purpose design is to store image data in the image-storing device in the arena telecom server. The stored image data can be transmitted instantly through Asymmetric Digital Subscriber Line (ADSL) connection; hence user is able to view the request images more conveniently and efficiently.

The public security problem in Taiwan area worsens through the past few years. While criminal rate rose, public living standard was being affected dramatically. As a result, many of the neighborhoods, by themselves, started to set up security groups in order to increase the safety around the area. Neighborhoods also set up the surveillance system at the streets and corners in order to watch and record states for each area. This, in the end, can effectively lowered the criminal rate and prevent occurring of the criminal act.

Conventional surveillance system is combined with several CCTV, surveillance monitor, and video machine. All the video footages were transmitted from the fixed CCTV through the video transmission line to the surveillance monitor. Video machine is then recording those video footages into a tape after they are transmitted. Therefore crime act can be reduced by way of this surveillance system.

However, there are obvious deficiencies in above surveillance system. Firstly, video footage quality cannot be enhanced by using the video machine and tape as image storing tools. Video types get defected after recycling, which makes real affect on recorded footages. Secondly, the capacity of such tapes is limited. It occurs difficulties when either managing or storing such video footage. This will affect the timing and accuracy when referring back to the video footage. Thirdly, specialist is required to keep track on each individual surveillance system. Which is highly cost and waste of human resource. Lastly, since a number of CCTV is required in such surveillance system, the additional works will also be required when constructing such system including new cable line for each additional image storing tool (CCTV, surveillance monitor, and video machine). This will be uneconomic.

The commercial design is a digital swift video controller system, which can be used, in a wide range spreading area. Storing image data from those wide spreading digital video camera by using a high capacity image-storing tool in main telecom server. All these image data is then accumulated in the central control unit, and managed by the specialist. User can access to the required image data from their personal computer upon their personal authorized state and pin code providing there is an Asymmetric Digital Subscriber Line (ADSL) connection.

The present invention can be best understood through the following description and accompanying drawings wherein:

### BRIEF DESCRIPTION OF THE DRAWINGS

FIG. 1 shows a flowchart of the present invention;

FIG. 2 shows other flowchart of the present invention;

FIG. 3 shows an embodiment of the present invention.

### DETAIL DESCRIPTION OF THE PREFERRED EMBODIMENTS

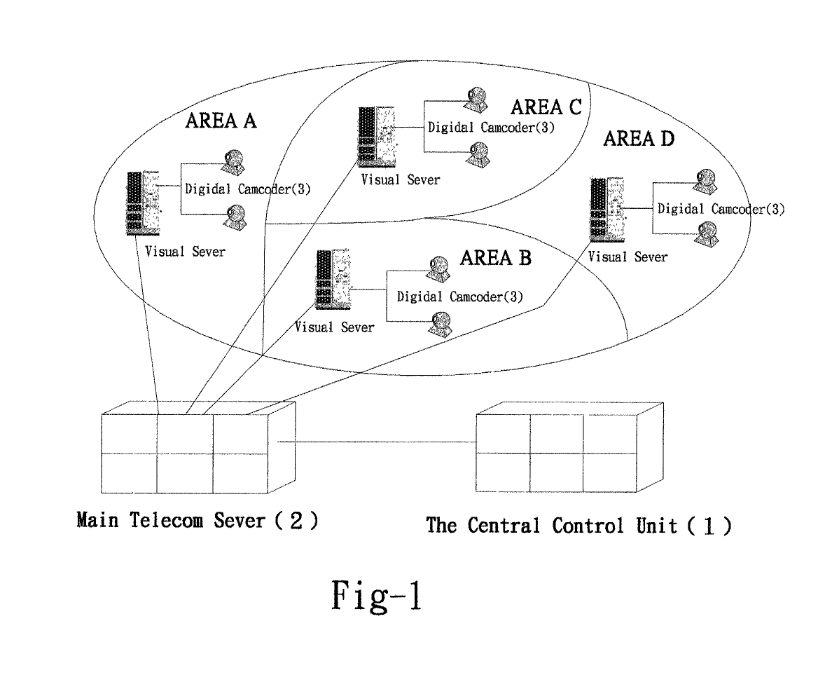

Please refer to FIG. 1. A digital swift video controller system that can be used in a wide spreading area. The command center (1) contains a high capacity image-storing device (10), which is formed by magnetic disk and CD-Rom. This image-storing device can record and secure all kind of image data accurately. All the image data are transmitted from the wide spreading digital video camera, through image server and main telecom server (2) to the central control unit (1). Each individual digital video camera will be assigned with a IP address, all the image data which taped by the digital video camera is then stored in the assigned magnetic disk and CD-Rom. Specialist is then managing and monitoring all these image data in the central control unit, in case of any emergency, they will inform the security guard immediately hence enhanced the mobility of security and stop the crime instantly.

### SUMMARY OF THE INVENTION

It is therefore a primary objective of the present invention to provide a digital swift video controller system. By use of the type system, criminal rate will be lower down effectively, hence, offer a maximum safety environment to the general public. The present invention is able to offer user a more convenient and effective surveillance system.

The further objective of the present invention to provide the above, digital swift video controller system is manufactured at a lower cost compare to the conventional surveillance system when functioning in a wide spreading area so that the digital swift video controller system can be popular used.

According to the above objectives, a digital swift video controller system which can be used in a wide spreading area. The command center (1) contains a high capacity image-storing device (10), which is formed by magnetic disk and CD-Rom. This image-storing device can record and secure all kind of image data accurately. All the image data are transmitted from the wide spreading digital video camera, through image server and main telecom server (2) to the central control unit (1). Each individual digital video camera will be assigned with a IP address, all the image data which taped by the digital video camera is then stored in the assigned magnetic disk and CD-Rom. Specialist is then managing and monitoring all these image data in the central control unit.

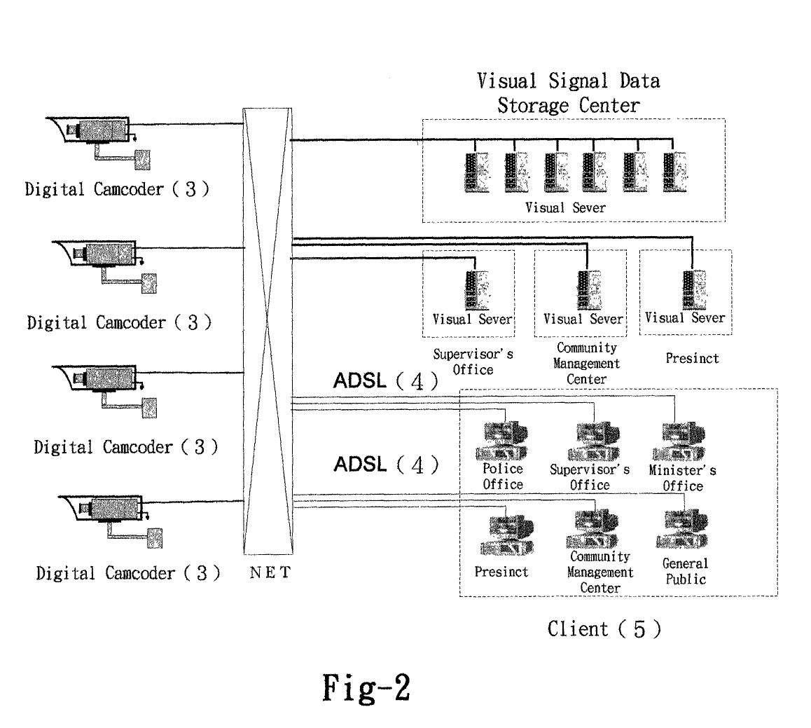

Refer to FIG. 2 the image data can be transmitted to user by using image server and Asymmetric Digital Subscriber Line (ADSL). Each individual user will be assigned with an authorized state and pin code in order to access to the requested image data. User are then able to view the request images instantly upon their authorized state and pin code either live or historically on any personal computer providing there is an Asymmetric Digital Subscriber Line (ADSL) connection. By way of this system, user will not have to assign to a particular computer in order to monitoring the requested image, hence offer a maximum convenience.

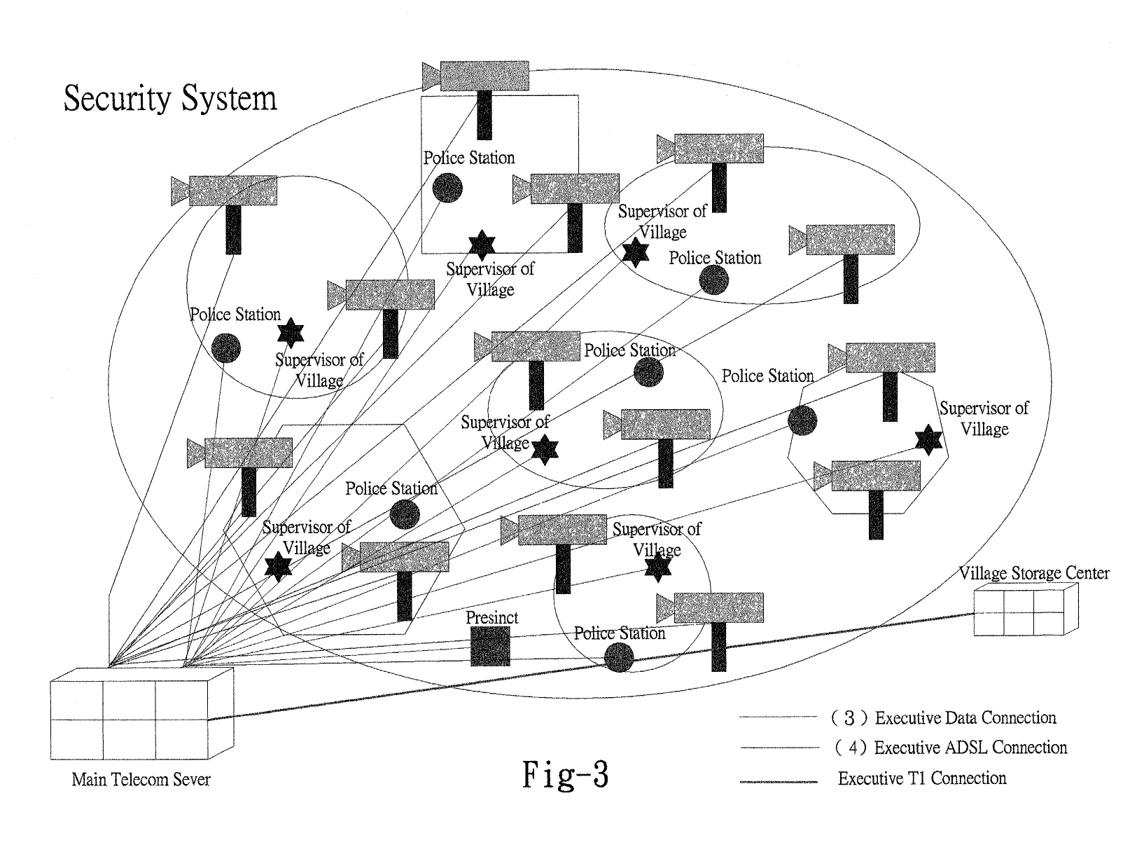

Please refer to FIG. 3 an embodiment of the present invention. Each individual digital video camera will be will be placed in the preferred location and assigned with different IP address. All image data will be sent through data cable instantly to main telecom server in the central control unite, for example local council. Council people or police can then monitoring on those image data through Asymmetric Digital Subscriber Line (ADSL) connection in order to form a maximum safety surveillance system at local community.

Furthermore, user can also place the digital video camera in the preferred location, for example their home. By way of this, they can keep eye on the elder people and young if they have no time to look after. They can appoint a security guard to take care of their love ones in case of any emergency.

In addition, the present invention can also be placed at any main road to keep track on the traffic instantly. This will enable user to obtain most updated traffic information so they can rearrange their traveling plan to prevent the heavy traffic hence to save the traveling time.

As above descript, there are several advantages if the present invention were adopted. Firstly, all the image data will be managed and monitored 24 hours a day. In case of bade setting, user will be able connect to the net, monitoring the image data transmitted from the assigned digital video camera, either live or historically, upon their authorized state and pin code to keep eye on their love ones.

Secondly, in a wide spreading area, for example local community. User will be able to track any criminal act instantly from the digital network surveillance system. This, in the end, can effectively lowered the criminal rate and prevent occurring of the criminal act.

Thirdly, surveillance people can take full remote control of a wide spreading area that they monitored at a particular place, without physically checking each individual surveillance monitor, which saves human resources.

Fourthly, by using Asymmetric Digital Subscriber Line (ADSL) connection, enormous costs on fitting cable wires will be cutting down as a result of digital network.

Lastly, the quality of image that stored in the high capacity magnetic disk and CD-Rom will be enhanced by using the high technology. Which offers a more accurate and clear records for security purposes. This, in the end, can effectively lowered the criminal rate and prevent occurring of the criminal act.

What is claimed is:

1. Digital swift video controller system that can be used in a wide spreading area. The present system is activated by transmitting digital video camera images to the arena telecom server and then stored in the high capacity image-storing device. Specialist is then monitoring all these image data in the central control unit and then they are able to transmit the requested image data to user. These image data are transmitted through Asymmetric Digital Subscriber Line (ADSL) offered by the central telecom company in Taiwan upon users personal authorized estate and pin code. By way of transmitting image data, user will be able to view the request images instantly either live or historical on any personal computer providing there is an Asymmetric Digital Subscriber Line (ADSL) connection.

2. Digital swift video controller system as claimed in claim 1, wherein a high capacity image-storing device is a high capacity recordable magnetic disk or CD-Rom.

3. Digital swift video controller system as claimed in claim 1, wherein a digital video camera can be placed in any location where user requested, hence enable user an instant view of video footage or image data.
